(19) United States
(12) Patent Application Publication
(10) Pub. No.: US 2022/0113134 A1
(43) Pub. Date: Apr. 14, 2022

(54) MULTIFUNCTIONAL LEVEL GAUGE FOR APPLYING NANO ADHESIVE TAPE FOR CONVENIENT AND QUICK POSITIONING

(71) Applicant: EXCELLENT NEW PRECISION TECHNOLOGY LIMITED, Hong Kong (HK)

(72) Inventor: Chefung CHAN, Hong Kong (HK)

(21) Appl. No.: 17/645,254

(22) Filed: Dec. 20, 2021

Related U.S. Application Data
(63) Continuation of application No. PCT/CN2020/071008, filed on Jan. 8, 2020.

(30) Foreign Application Priority Data
Jul. 18, 2019 (CN) 201910648360.5

(51) Int. Cl. G01C 9/12

(52) U.S. Cl. CPC G01C 9/12; G01C 2009/066

(57) ABSTRACT

Disclosed is a multifunctional level gauge for applying a nano adhesive tape for convenient and quick positioning. The multifunctional level gauge comprises a level ruler (1) with a hollow profile, wherein a transverse level (2) and a vertical level (3) are respectively arranged on the level ruler (1), at least two nano adhesive tapes (4) for convenient and quick positioning are pasted and fixed to a left side surface of the level ruler (1), and an adhesive tape positioning structure is arranged below the nano adhesive tapes (4); and an angle measurement device (5) capable of performing 360-degree omnidirectional measurement and a swing-type offset measurement structure for cooperatively observing whether an intersection plane is inclined are arranged at an upper end portion of the level ruler (1), and the swing-type offset measurement structure comprises a swing connection rod (6), a counterweight cone (7) and an alignment pointer (8). On the basis of achieving 360-degree omnidirectional angle measurement, horizontal measurement, vertical measurement, and plane measurement can be achieved at the same time; during measurement, whether a measurement plane is inclined can be determined by observing whether the counterweight cone (7) coincides with the alignment pointer (8); and the multifunctional level gauge can be directly pasted to the measurement plane, the level gauge can be conveniently placed by a worker, the working efficiency is improved, and the measuring effect is good.

### CROSS-REFERENCE TO RELATED APPLICATIONS

This application is a continuation of International Patent Application Number PCT/CN2020/071008, filed on Jan. 8, 2020, which claims the benefit and priority of Chinese Patent Application Number 201910648360.5, filed on Jul. 18, 2019, the disclosures of which are incorporated herein by reference in their entireties.

### TECHNICAL FIELD

The invention relates to the technical field of building measuring leveling ruler, in particular to a multifunctional leveling meter for convenient positioning using nano adhesive stickers.

### BACKGROUND

In construction engineering, decoration and other industries, it is usually necessary to measure and adjust horizontal angles, and horizontal rulers are generally used as instruments for measuring the level. At present, there are many kinds of leveling rulers on the market, which can realize horizontality and verticality measurements, as well as 45° angle measurements. However, the existing leveling rulers cannot realize 360° all directional measurement in addition to conventional horizontality and verticality measurements. Some leveling rulers, such as electronic leveling rulers, can realize it, but they are very expensive, which is not advantageous for wide use.

In addition, when an existing leveling meter is used to measure the horizontal plane or vertical plane of an object, it must be held and fixed by hand to keep it fitted snugly to the measured object. Therefore, holding the instrument by hand determines the contact degree, and due to human factors, it will directly affect the accuracy of the measurement and limit the applicable range of the instrument. In practice, it is found that setting nano adhesive stickers on leveling instruments can make positioning convenient and the adhesive effect excellent. However, nano adhesive stickers also have the following disadvantages: for example, adsorbing dust, mud and sand; and if measurement is performing on some objects with smooth surface, such as glass and stainless steel, a nano adhesive film is easily out of position because the leveling ruler needs to frequently shift for the measurement operation.

### SUMMARY

Aiming at the problems of the prior art, the resent application proposes a multifunctional leveling meter for convenient positioning using nano adhesive stickers.

In order to solve the above technical problems, the present application adopts the following technical solution:

A multifunctional leveling meter for convenient positioning using nano adhesive stickers comprises a leveling ruler which is a hollow section bar, wherein the leveling ruler is provided with a horizontal leveler and a vertical leveler, respectively, the horizontal leveler is arranged within the lower end of the leveling ruler, and the vertical leveler is arranged on the left side of the leveling ruler, the left side surface of the leveling ruler is sticked and fixed with at least two nano adhesive stickers for convenient positioning, an adhesive sticker positioning structure is arranged under the nano adhesive sticker; the upper end of the leveling ruler is provided with an angle measuring device capable of 360° all directional measurement and a swing type deflection measuring structure for cooperatively observing whether the intersecting surface is inclined or not, the swing type deflection measuring structure comprises a swing connecting rod, a counterweight cone and an alignment needle, wherein the counterweight cone is vertically mounted in the middle of the swing connecting rod, and the alignment needle vertically points to the counterweight cone.

Wherein, the adhesive sticker positioning structure comprises a positioning and mounting base inserted into the leveling ruler and a positioning and mounting plate, and the upper surface of the positioning and mounting plate is provided with a cavity for accommodating nano adhesive stickers; directional insertion slots are respectively provided on the left and right sides of the positioning and mounting base, and insertion portions fitted with the directional insertion slots are provided on the left and right sides of the positioning and mounting plate, the positioning and mounting plate and the positioning and mounting base are integrally assembled by inserting the insertion portions into the positioning and insertion slots.

Further, a positioning cavity is provided in the slot wall of the directional insertion slot, and the insertion portion is provided with a positioning bump corresponding to the positioning cavity, when the positioning and mounting plate and the positioning and mounting base are inserted into place, the positioning bump is exactly located in the positioning cavity.

Further, the outer side of the positioning and mounting plate is provided with a metal pressing frame for reinforcing the nano adhesive sticker, after being bent, both sides of the metal pressing frame are clamped and fixed with both sides of the positioning and mounting plate, and a strip hole for facilitating the exposing of the nano adhesive sticker is provided in the middle of the metal pressing frame.

Preferably, the angle measuring device and the swing type deflection measuring structure are arranged up and down in a completely transparent protective shell, the protective shell comprises a front shell cover and a rear shell cover which are combined with each other, the lower end of the front shell cover is inserted and fixed inside the upper end of the leveling ruler, and the middle portion of the front shell cover is provided with positioning and mounting portions for fixedly mounting the angle measuring device and the swing type deflection measuring structure.

Wherein, the angle measuring device comprises a circular dial and a dial fixture, wherein a rotating shaft is arranged at the center of the circular dial, a needle perpendicular to the rotating shaft is provided at the rotating shaft, and a counterweight block is connected at the tail end of the needle; the circumference of the dial fixing member is provided with positioning and plug-in posts corresponding to the positioning and mounting portions, when the front shell cover and the rear shell cover are combined together, the two ends of the rotating shaft and the dial fixture are respectively fixed between the front shell cover and the rear shell cover, and the swing connecting rod is horizontally and transversely mounted between the front shell cover and the rear shell cover.

Wherein, a separate mounting chamber is provided at and extends from the lower end of the front shell cover, and the separate mounting chamber is integrally formed with the front shell cover; an LED lamp, a circuit board, a rechargeable battery and a battery cover are arranged in the separate mounting chamber, the LED lamp and the rechargeable battery are both electrically connected with the circuit board, one side of the circuit board is provided with a USB interface for external connection and charging and a push switch for controlling the LED lamp, the sides of the battery cover are provided with snap-fit snap joints, the battery cover is connected with the separate mounting chamber by snap-fit snap joints, and the LED lamp, the circuit board and the rechargeable battery are encapsulated inside the separate mounting chamber.

Further, the separate mounting chamber is provided with a transparent plate, and the transparent plate is provided with a circular hole adapted to the size of the LED lamp, and one end of the LED lamp protrudes out of the circular hole; and the transparent plate is further provided with a circular fixing hole, and the end of the alignment needle is inserted and fixed in the circular fixing hole.

Further, the leveling ruler is provided with a charge sealing rubber sheet on the side of the USB interface, and a rubber pull rivet for plugging in the leveling ruler is arranged at one end of the charge sealing rubber sheet.

Wherein, the top of the protective shell and the bottom of the leveling ruler are respectively provided with fall protection silicone rubber parts, each fall protection silicone rubber part comprises a rubber plug-in post and several silicone rubber strips, the rubber plug-in post is transversely provided with a locking bolt and a fixing nut, when the rubber plug-in post is inserted into the inside of the protective shell and the leveling ruler, the locking bolt is threaded with the fixing nut to fix the fall protection silicone rubber part.

Wherein, the lower end of the leveling ruler is provided with a plastic hanger for convenient hanging and placing, the plastic hanger is fixed through in the leveling ruler, and the plastic hanger comprises a front hanger cover and a rear hanger cover which can be snap-fitted with each other; the plastic hanger is provided with a first circular through hole for hanging and a second circular through hole for mounting the horizontal leveler, the horizontal leveler is circular in shape, and the horizontal leveler is embedded within the second circular through hole.

Further, there is a hanger connector between the first circular through hole and the second circular through hole, and the surface of the hanger connector is provided with a recess for sticking product's labels.

Wherein, the vertical leveler is arranged within a rectangular fixture, the rectangular fixture comprises a rectangular insertion portion and a trapezoidal mounting portion, the left side of the leveling ruler is provided with a trapezoidal opening, the vertical leveler is fixedly arranged within the trapezoidal mounting portion, the rectangular fixture is transversely inserted and fixed on the leveling ruler through the rectangular insertion portion.

### Advantageous Effects of Invention

In the present application, the upper end of the leveling ruler is provided with an angle measuring device capable of 360° all directional measurement and a swing type deflection measuring structure. In addition to 360° all directional angle measurement, horizontal, vertical and plane measurements can be carried out at the same time. The counterweight cone is maintained in a vertical state all the time due to the gravity action of the counterweight cone, and during measurement, whether the surface to be measured is inclined can be judged by observing whether the counterweight cone coincides with the alignment needle. In the present application, the multifunctional leveling meter can be directly sticked on the surface to be measured by the nano adhesive sticker on the side, so as to facilitate operators to place the leveling meter, improve operation efficiency and show a better measuring effect.

### BRIEF DESCRIPTION OF THE DRAWINGS

FIG. 1 is a perspective view of the multifunctional leveling meter provided by the present application;

FIG. 2 is a exploded structural view of the multifunctional leveling meter provided by the present application;

FIG. 3 is a in use status reference view of the multifunctional leveling meter provided by the present application;

FIG. 4 is a structural view of an angle measuring device according to the present application;

FIG. 5 is a further perspective view of the multifunctional leveling meter provided by the present application;

FIG. 6 is an exploded structural view of the adhesive sticker positioning structure of the present application.

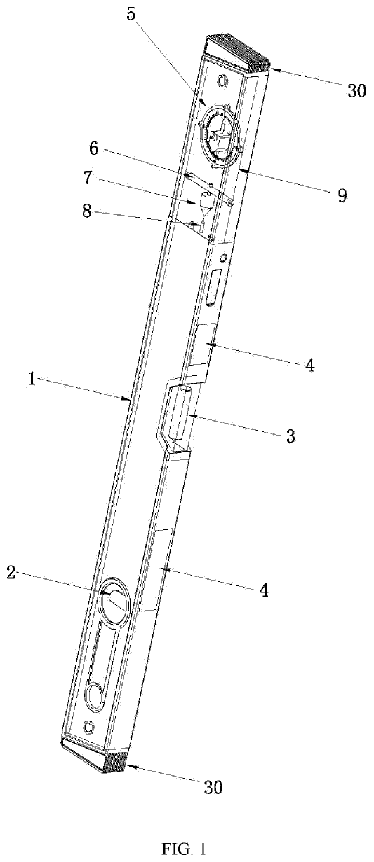

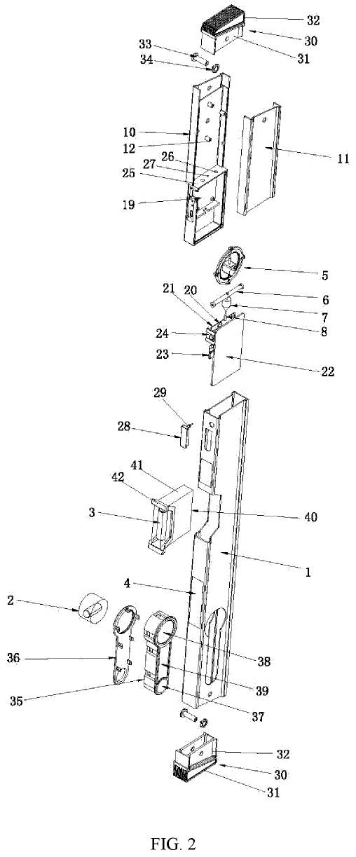

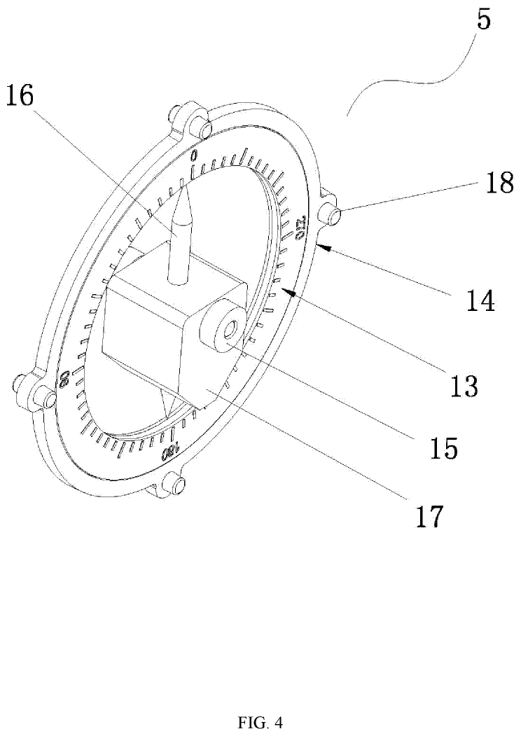

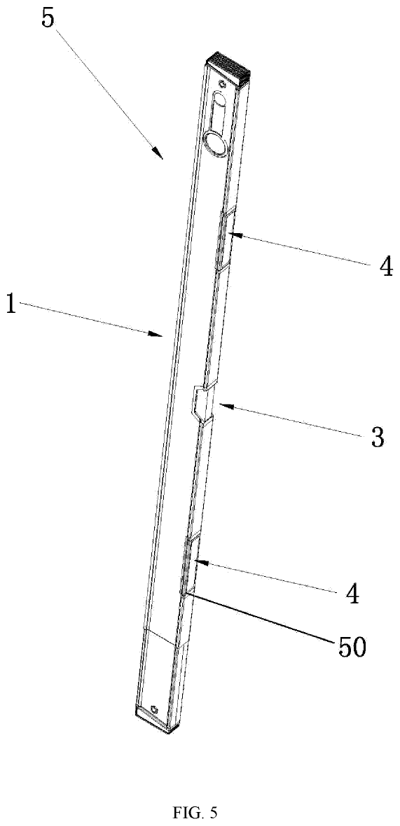

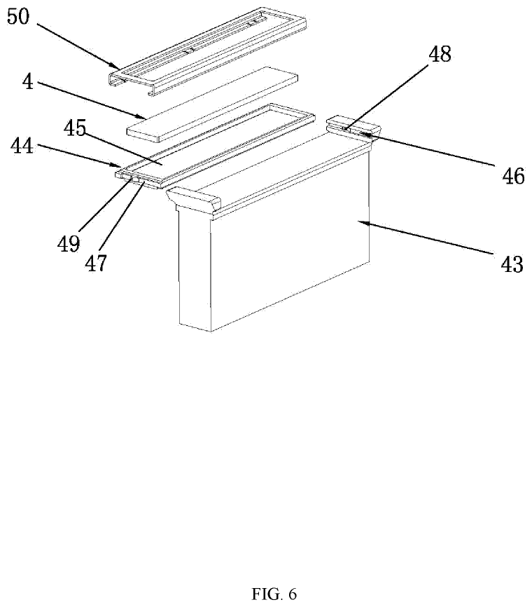

Reference numerals in FIGS. 1 to 6 include:

1 leveling ruler; 2 horizontal leveler; 3 vertical leveler; 4 nano adhesive sticker; 5 angle measuring device; 6 swing connecting rod; 7 counterweight cone; 8 alignment needle; 9 protective shell; 10 front shell cover; 11 rear shell cover; 12 positioning and mounting portion; 13 circular dial; 14 dial fixture; 15 rotating shaft; 16 needle; 17 counterweight block; 18 positioning and plug-in post; 19 separate mounting chamber; 20 LED lamp; 21 circuit board; 22 battery cover; 23 USB interface; 24 push switch; 25 transparent plate; 26 circular hole; 27 circular fixing hole; 28 charge sealing rubber sheet; 29 rubber pull rivet; 30 fall protection silicone rubber part; 31 rubber plug-in post; 32 silicone rubber strip; 33 locking bolt; 34 fixing nut; 35 front hanger cover; 36 rear hanger cover; 37 first circular through hole; 38 second circular through hole; 39 hanger connector; 40 rectangular fixture; 41 rectangular insertion portion; 42 trapezoidal mounting portion; 43 positioning and mounting base; 44 positioning and mounting plate; 45 cavity; 46 directional insertion slot; 47 insertion portion; 48 positioning cavity; 49 positioning bump; 50 metal pressing frame.

### DETAILED DESCRIPTION

For an easier understanding by those skilled in the art, the present application will be further explained below in conjunction with the embodiments and the accompanying drawings and the contents referred to in the embodiments are not limiting of the present application. The present application is described in detail below in conjunction with the accompanying drawings.

See FIGS. 1 to 4, the present application provides a multifunctional leveling meter for convenient positioning using nano adhesive stickers comprising a leveling ruler 1 which is a hollow section bar. The leveling ruler 1 is provided with a horizontal leveler 2 and a vertical leveler 3, respectively. The horizontal leveler 2 is arranged within the lower end of the leveling ruler 1, and the vertical leveler 3 is arranged on the left side of the leveling ruler 1. The left side surface of the leveling ruler 1 is sticked and fixed with at least two nano adhesive stickers 4 for convenient positioning. An adhesive sticker positioning structure is arranged under the nano adhesive sticker 4. The nano adhesive sticker 4 has the characteristics of ease of use and high fixability, and can be applied in many application scenarios, for example, it can be sticked on any smooth surface. For example, it can be sticked on glass facades, stainless steel surfaces, wood surfaces, aluminum surfaces, ceramic tiles and painted walls, etc. When in use, an operator holds the right side of the leveling ruler 1, and fit the left side of the leveling ruler 1 snugly to the surface of the object to be measured. Applying nano adhesive sticker 4 on the multifunctional leveling meter is a new breakthrough in measurement applied technology. As another embodiment, several magnet blocks can be fixedly arranged inside the right side of the leveling ruler 1 of the present application, and the multifunctional leveling meter can be tightly sucked on the surface of the object to be measured of iron through the magnet blocks, so that the multifunctional leveling meter can be more widely utilized. In the present application, the multifunctional leveling meter can be directly sticked on the surface to be measured by the nano adhesive sticker 4 on the side or sucked tightly on the surface of the object to be measured made of iron by means of magnetic attraction, so as to facilitate operators to place the leveling meter, improve operation efficiency and show a better measuring effect.

In the present application, the adhesive sticker positioning structure comprises a positioning and mounting base 43 inserted into the leveling ruler and a positioning and mounting plate 44, wherein the upper surface of the positioning and mounting plate 44 is provided with a cavity 45 for accommodating the nano adhesive sticker. Directional insertion slots 46 are respectively provided on the left and right sides of the positioning and mounting base 43, and insertion portions 47 fitted with the directional insertion slots 46 are provided on the left and right sides of the positioning and mounting plate 44. The positioning and mounting plate 44 and the positioning and mounting base 43 are integrally assembled by inserting insertion portions 47 into positioning and insertion slots 46. Further, a positioning cavity 48 is provided in the slot wall of the directional insertion slot 46, and the insertion portion 47 is provided with a positioning bump 49 corresponding to the positioning cavity 48. When the positioning and mounting plate 44 and the positioning and mounting base 43 are inserted into place, the positioning bump 49 is exactly located in the positioning cavity 48, which can avoid the error of not being mounted in place. Further, the outer side of the positioning and mounting plate 44 is provided with a metal pressing frame 50 for reinforcing the nano adhesive sticker. After being bent, both sides of the metal pressing frame 50 are clamped and fixed with both sides of the positioning and mounting plate 44, and a strip hole for facilitating the exposing of the nano adhesive sticker is provided in the middle of the metal pressing frame 50.

In the present application, the nano adhesive sticker 4 and the positioning and mounting plate 44 are fixedly assembled integrally by using the metal pressing frame 50. The nano adhesive sticker film is firmly pressed by the metal pressing frame 50, so that the nano adhesive sticker 4 is conveniently inserted and mounted on the positioning and mounting base 43, and the front and back surfaces are conveniently swapped for further use. If the stickiness of the nano adhesive sticker 4 become insufficient after being used for a period, the nano adhesive sticker 4 and the positioning and mounting plate 44 can be replaced as a whole without separately re-sticking and fixing the nano adhesive sticker 4. When a measurement operation is to be performed, the positioning and mounting plate 44 is sticked on the object to be measured with the side surface provided with the nano adhesive sticker 4 facing outward to perform the measurement, which is easy to observe. When measurement is not needed or after use, the nano adhesive sticker 4 and the positioning and mounting plate 44 are removed and turned over as a whole, and the side of the positioning and mounting plate 44 provided with the nano adhesive sticker 4 is turned to be facing inward, so that the nano adhesive sticker 4 is prevented from long term exposure to the outside, and the nano adhesive sticker can be well stored and protected. The service life of nano adhesive sticker 4 can be prolonged.

In the present application, the upper end of the leveling ruler 1 is provided with an angle measuring device 5 capable of 36020 all directional measurement and a swing type deflection measuring structure for cooperatively observing whether the intersecting surface is inclined or not. Specifically, the swing type deflection measuring structure comprises a swing connecting rod 6, a counterweight cone 7 and an alignment needle 8, wherein the counterweight cone 7 is vertically mounted in the middle of the swing connecting rod 6, and the alignment needle 8 vertically points to the counterweight cone 7. The counterweight cone 7 is maintained in a vertical state all the time due to the gravity action of the counterweight cone 7, and during measurement, whether the surface to be measured is inclined can be judged by observing whether the counterweight cone 7 coincides with the alignment needle 8.

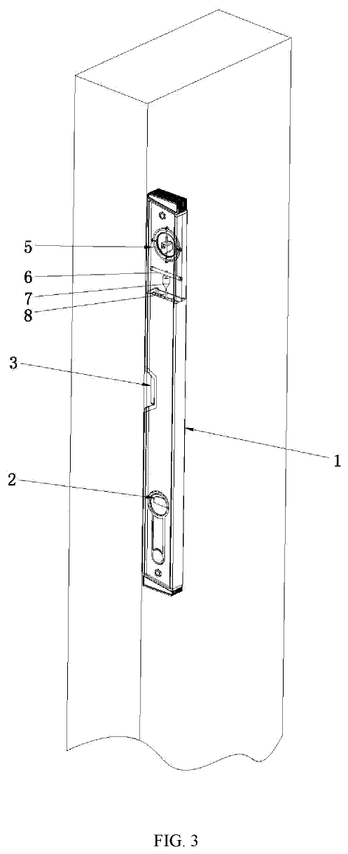

Preferably, the angle measuring device 5 and the swing type deflection measuring structure are arranged up and down in a completely transparent protective shell 9. The protective shell 9 comprises a front shell cover 10 and a rear shell cover 11 which are combined with each other. The lower end of the front shell cover 10 is inserted and fixed inside the upper end of the leveling ruler 1, and the middle portion of the front shell cover 10 is provided with positioning and mounting portions 12 for fixedly mounting the angle measuring device 5 and the swing type deflection measuring structure. In the present application, the protective shell 9 serves as the mounting carrier of the angle measuring device 5 and the swing type deflection measuring structure, and the protective shell 9 is made of completely transparent PC material, which is convenient for observation and can reduce the overall weight of the leveling meter.

Wherein, the angle measuring device 5 comprises a circular dial 13 and a dial fixture 14, wherein a rotating shaft 15 is arranged at the center of the circular dial 13, a needle 16 perpendicular to the rotating shaft 15 is provided at the rotating shaft 15, and a counterweight block 17 is connected at the tail end of the needle 16. The circumference of the dial fixing member 14 is provided with positioning and plug-in posts 18 corresponding to the positioning and mounting portions 12, when the front shell cover 10 and the rear shell cover 11 are combined together, the two ends of the rotating shaft 15 and the dial fixture 14 are respectively fixed between the front shell cover 10 and the rear shell cover 11, and the swing connecting rod 6 is horizontally and transversely mounted between the front shell cover 10 and the rear shell cover 11. When in use, due to the action of gravity, the needle 16 always points vertically upward, therefore in the case where the leveling ruler is vertical placed (as shown in FIG. 3), the scale pointed by the needle 16 is set to 0, and scales such as 90°, 180° and 270° are sequentially set clockwise, so that when in use, the scale pointed by the needle 16 will be the angle of the measured surface.

In the present application, a separate mounting chamber 19 is provided at and extends from the lower end of the front shell cover 10, and the separate mounting chamber 19 is integrally formed with the front shell cover 10. An LED lamp 20, a circuit board 21, a rechargeable battery (not shown in the figure) and a battery cover 22 are arranged in the separate mounting chamber 19. The LED lamp 20 and the rechargeable battery are both electrically connected with the circuit board 21. One side of the circuit board 21 is provided with a USB interface 23 for external connection and charging and a push switch 24 for controlling the LED lamp 20. The sides of the battery cover 22 are provided with snap-fit snap joints. The battery cover 22 is connected with the separate mounting chamber 19 by snap-fit snap joints, and the LED lamp 20, the circuit board 21 and the rechargeable battery are encapsulated inside the separate mounting chamber 19, so that they can be conveniently assembled inside the leveling ruler 1. Further, the separate mounting chamber 19 is provided with a transparent plate 25, and the transparent plate 25 is provided with a circular hole 26 adapted to the size of the LED lamp 20, and one end of the LED lamp 20 protrudes out of the circular hole 26; and the transparent plate 25 is further provided with a circular fixing hole 27, and the end of the alignment needle 8 is directly and interferingly inserted and fixed in the circular fixing hole 27, so that the alignment needle 8 is convenient and simple to position and mount, and will not readily loosen. In addition, by providing the LED lamp 20 in the present application, with the irradiation of the LED lamp 20 during measurement, the visibility is better, which is convenient for accurate measurement.

Further, the leveling ruler 1 is provided with a charge sealing rubber sheet 28 on the side of the USB interface 23, and a rubber pull rivet 29 for plugging in the leveling ruler 1 is arranged at one end of the charge sealing rubber sheet 28, wherein the rubber pull rivet 29 enables the rotation of the charge sealing rubber sheet 28 relative to the leveling ruler 1. When the charge sealing rubber sheet 28 is snap-fitted on the outside of the USB interface 23, a good waterproof sealing effect is obtained, preventing water vapor from penetrating into the separate mounting chamber 19.

In the present application, the top of the protective shell 9 and the bottom of the leveling ruler 1 are respectively provided with fall protection silicone rubber parts 30, each fall protection silicone rubber part 30 comprises a rubber plug-in post 31 and several silicone rubber strips 32. The rubber plug-in post 31 is transversely provided with a locking bolt 33 and a fixing nut 34. When the rubber plug-in post 31 is inserted into the inside of the protective shell 9 and the leveling ruler 1, the locking bolt 33 is threaded with the fixing nut 34 to fix the fall protection silicone rubber part 30. If the multifunctional leveling meter accidentally falls to the ground, the fall protection silicone rubber parts 30 located at both ends can play a role of cushioning and protection to prevent the level meter from damage caused by hard contact.

In the present application, the lower end of the leveling ruler 1 is provided with a plastic hanger for convenient hanging and placing, the plastic hanger is fixed through in the leveling ruler 1, and the plastic hanger comprises a front hanger cover 35 and a rear hanger cover 36 which can be snap-fitted with each other. The plastic hanger is provided with a first circular through hole 37 for hanging and a second circular through hole 38 for mounting the horizontal leveler 2. After the multifunctional leveling meter is used, it is hung up and placed through the first circular through hole 37, which is convenient for placing and taking. The horizontal leveler 2 is circular in shape, and the horizontal leveler 2 is embedded within the second circular through hole 38.

Further, there is a hanger connector 39 between the first circular through hole 37 and the second circular through hole 38, and the surface of the hanger connector 39 is provided with a recess for sticking product's labels.

In the present application, the vertical leveler 3 is arranged within a rectangular fixture 40. The rectangular fixture 40 comprises a rectangular insertion portion 4741 and a trapezoidal mounting portion 42. The left side of the leveling ruler 1 is provided with a trapezoidal opening. The vertical leveler 3 is fixedly arranged within the trapezoidal mounting portion 42. The rectangular fixture 40 is transversely inserted and fixed on the leveling ruler 1 through the rectangular insertion portion 4741.

The contents described above are only preferred embodiments of the present application and does not limit the present application in any way. Although the present application is disclosed as above in preferred embodiments, it is not intended to limit the present application. Any person skilled in the art can make equivalent embodiments where minor changes or modifications are equivalent variations utilizing the technical contents disclosed above, without departing from the scope of the technical solution of the present application. Any simple modifications, equivalent variations and modifications to the above embodiments which do not depart from the content of the technical solution of the present application and which are based on the technology of the present application fall within the scope of the technical solution of the present application.

1. A multifunctional leveling meter for convenient positioning using nano adhesive stickers comprising a leveling ruler which is a hollow section bar, wherein the leveling ruler is provided with a horizontal leveler and a vertical leveler, respectively, the horizontal leveler is arranged within the lower end of the leveling ruler, and the vertical leveler is arranged on the left side of the leveling ruler, characterized in that:
the left side surface of the leveling ruler is sticked and fixed with at least two nano adhesive stickers for convenient positioning, an adhesive sticker positioning structure is arranged under the nano adhesive sticker; the upper end of the leveling ruler is provided with an angle measuring device capable of 360° all directional measurement and a swing type deflection measuring structure for cooperatively observing whether the intersecting surface is inclined or not, the swing type deflection measuring structure comprises a swing connecting rod, a counterweight cone and an alignment needle, wherein the counterweight cone is vertically mounted in the middle of the swing connecting rod, and the alignment needle vertically points to the counterweight cone.

2. The multifunctional leveling meter for convenient positioning using nano adhesive stickers according to claim 1, characterized in that: the adhesive sticker positioning structure comprises a positioning and mounting base inserted into the leveling ruler and a positioning and mounting plate, and the upper surface of the positioning and mounting plate is provided with a cavity for accommodating nano adhesive stickers; directional insertion slots are respectively provided on the left and right sides of the positioning and mounting base, and insertion portions fitted with the directional insertion slots are provided on the left and right sides of the positioning and mounting plate, the positioning and mounting plate and the positioning and mounting base are integrally assembled by inserting the insertion portions into the positioning and insertion slots.

3. The multifunctional leveling meter for convenient positioning using nano adhesive stickers according to claim 2, characterized in that: a positioning cavity is provided in the slot wall of the directional insertion slot, and the insertion portion is provided with a positioning bump corresponding to the positioning cavity, when the positioning and mounting plate and the positioning and mounting base are inserted into place, the positioning bump is exactly located in the positioning cavity.

4. The multifunctional leveling meter for convenient positioning using nano adhesive stickers according to claim 2, characterized in that: the outer side of the positioning and mounting plate is provided with a metal pressing frame for reinforcing the nano adhesive sticker, after being bent, both sides of the metal pressing frame are clamped and fixed with both sides of the positioning and mounting plate, and a strip hole for facilitating the exposing of the nano adhesive sticker is provided in the middle of the metal pressing frame.

5. The multifunctional leveling meter for convenient positioning using nano adhesive stickers according to claim 1, characterized in that: the angle measuring device and the swing type deflection measuring structure are arranged up and down in a completely transparent protective shell, the protective shell comprises a front shell cover and a rear shell cover which are combined with each other, the lower end of the front shell cover is inserted and fixed inside the upper end of the leveling ruler, and the middle portion of the front shell cover is provided with positioning and mounting portions for fixedly mounting the angle measuring device and the swing type deflection measuring structure.

6. The multifunctional leveling meter for convenient positioning using nano adhesive stickers according to claim 5, characterized in that: the angle measuring device comprises a circular dial and a dial fixture, wherein a rotating shaft is arranged at the center of the circular dial, a needle perpendicular to the rotating shaft is provided at the rotating shaft, and a counterweight block is connected at the tail end of the needle;
the circumference of the dial fixing member is provided with positioning and plug-in posts corresponding to the positioning and mounting portions, when the front shell cover and the rear shell cover are combined together, the two ends of the rotating shaft and the dial fixture are respectively fixed between the front shell cover and the rear shell cover, and the swing connecting rod is horizontally and transversely mounted between the front shell cover and the rear shell cover.

7. The multifunctional leveling meter for convenient positioning using nano adhesive stickers according to claim 5, characterized in that: a separate mounting chamber is provided at and extends from the lower end of the front shell cover, and the separate mounting chamber is integrally formed with the front shell cover; an LED lamp, a circuit board, a rechargeable battery and a battery cover are arranged in the separate mounting chamber, the LED lamp and the rechargeable battery are both electrically connected with the circuit board, one side of the circuit board is provided with a USB interface for external connection and charging and a push switch for controlling the LED lamp, the sides of the battery cover are provided with snap-fit snap joints, the battery cover is connected with the separate mounting chamber by snap-fit snap joints, and the LED lamp, the circuit board and the rechargeable battery are encapsulated inside the separate mounting chamber.

8. The multifunctional leveling meter for convenient positioning using nano adhesive stickers according to claim 7, characterized in that: the separate mounting chamber is provided with a transparent plate, and the transparent plate is provided with a circular hole adapted to the size of the LED lamp, and one end of the LED lamp protrudes out of the circular hole; and the transparent plate is further provided with a circular fixing hole, and the end of the alignment needle is inserted and fixed in the circular fixing hole.

9. The multifunctional leveling meter for convenient positioning using nano adhesive stickers according to claim 7, characterized in that: the leveling ruler is provided with a charge sealing rubber sheet on the side of the USB interface, and a rubber pull rivet for plugging in the leveling ruler is arranged at one end of the charge sealing rubber sheet.

10. The multifunctional leveling meter for convenient positioning using nano adhesive stickers according to claim 5, characterized in that: the top of the protective shell and the bottom of the leveling ruler are respectively provided with fall protection silicone rubber parts, each fall protection silicone rubber part comprises a rubber plug-in post and several silicone rubber strips, the rubber plug-in post is transversely provided with a locking bolt and a fixing nut, when the rubber plug-in post is inserted into the inside of the protective shell and the leveling ruler, the locking bolt is threaded with the fixing nut to fix the fall protection silicone rubber part.

11. The multifunctional leveling meter for convenient positioning using nano adhesive stickers according to claim 1, characterized in that: the lower end of the leveling ruler is provided with a plastic hanger for convenient hanging and placing, the plastic hanger is fixed through in the leveling ruler, and the plastic hanger comprises a front hanger cover and a rear hanger cover which can be snap-fitted with each other;
the plastic hanger is provided with a first circular through hole for hanging and a second circular through hole for mounting the horizontal leveler, the horizontal leveler is circular in shape, and the horizontal leveler is embedded within the second circular through hole.

12. The multifunctional leveling meter for convenient positioning using nano adhesive stickers according to claim 11, characterized in that: there is a hanger connector between the first circular through hole and the second circular through hole, and the surface of the hanger connector is provided with a recess for sticking product's labels.

13. The multifunctional leveling meter for convenient positioning using nano adhesive stickers according to claim 1, characterized in that: the vertical leveler is arranged within a rectangular fixture, the rectangular fixture comprises a rectangular insertion portion and a trapezoidal mounting portion, the left side of the leveling ruler is provided with a trapezoidal opening, the vertical leveler is fixedly arranged within the trapezoidal mounting portion, the rectangular fixture is transversely inserted and fixed on the leveling ruler through the rectangular insertion portion.
